(19) United States
(12) Patent Application Publication
(10) Pub. No.: US 2025/0093189 A1
(43) Pub. Date: Mar. 20, 2025

(54) MEASURING DEVICE FOR DETERMINING THE DENSITY, THE MASS FLOW RATE AND/OR THE VISCOSITY OF A FLOWABLE MEDIUM, AND METHOD FOR OPERATING SAME

(71) Applicant: Endress+Hauser Flowtec AG, Reinach (CH)

(72) Inventors: Hao Zhu, Freising (DE); Alfred Rieder, Landshut (DE); Yaoying Lin, Freising (DE); Robert Lalla, Lörrach (DE); Reinhard Huber, Bad Säckingen (DE)

(21) Appl. No.: 18/920,287

(22) Filed: Oct. 18, 2024

Related U.S. Application Data
(63) Continuation of application No. 17/055,853, filed on Nov. 16, 2020.

(30) Foreign Application Priority Data
May 18, 2018 (DE) 102018112002.8

(51) Int. Cl. G01F 1/84; G01N 9/00; G01N 11/00

(52) U.S. Cl. CPC G01F 1/8477; G01F 1/8422; G01F 1/8427; G01F 1/8431; G01N 9/002; G01N 11/00; G01N 2009/006

(57) ABSTRACT

A measuring device for determining density, mass flow rate and/or viscosity of a flowable medium includes: an oscillator including at least one oscillatable measuring tube for conveying the medium, and having at least one oscillatory mode, whose eigenfrequency depends on density of the medium; an exciter for exciting the oscillatory mode; at least one oscillation sensor for registering oscillations of the oscillator; and an operating-evaluating circuit, which is adapted to supply the exciter with an excitation signal, to register signals of the oscillation sensor, based on the signals of the oscillation sensor to ascertain current values of the eigenfrequency of the oscillator as well as variations of the eigenfrequency, and to determine a value characterizing density variations of the medium, wherein the value depends on a function, which is proportional to the variation of the eigenfrequency and has an eigenfrequency dependent normalization.

### CROSS-REFERENCE TO RELATED APPLICATIONS

The present application is a continuation application, which is related to and claims the priority benefit of U.S. patent application Ser. No. 17/055,853, filed Nov. 16, 2020, German Patent Application No. 10 2018 112 002.8, filed May 18, 2018, and International Patent Application No. PCT/EP2019/059951, filed Apr. 17, 2019, the entire contents of which are incorporated herein by reference.

### TECHNICAL FIELD

The present invention relates to a measuring device for determining density, mass flow rate and/or viscosity of a flowable medium and to a method for characterizing a multiphase medium, wherein the measuring device has at least one oscillator, which is contactable with the medium, and which has at least one oscillatory mode, whose eigenfrequency depends on density p of the medium. Such an oscillator can comprise a single, oscillatable measuring tube or a pair, or a plurality of pairs, of oscillatable measuring tubes conveying the medium.

### BACKGROUND

Multiphase media can be quite inhomogeneous, especially in the case of gas-containing liquids, when the gas is not dissolved in the form of microbubbles in the liquid phase, but, instead, is present in the form of free bubbles in the liquid phase. The presence of free bubbles can be an essential property of the medium, and such can, in given cases, be of great interest to detect qualitatively and/or quantitatively. From the perspective of a measuring device flowed through by an inhomogeneous medium, the inhomogeneities appear as density variations dp/dt. These bring about variations df/dt of the oscillation frequency of the oscillator, which correlate with the density variations dp/dt. Analysis of the variations of the oscillation frequency df/dt of the oscillator accordingly offers an approach for analyzing the density variations and therewith at given flow rate an indication of the degree of inhomogeneity of the medium.

In view of the multiplicity of available measuring device types of the field of the invention, a large effort is required with different measuring device types to reach comparable determinations regarding the occurrence of free bubbles. For this, as a rule, a series of measurements is required, in which the measuring devices are, in each case, supplied with media, which contain free bubbles, and the observed frequency variation of the oscillator is registered as a function of concentration of free bubbles, e.g., as a function of the gas volume fraction or gas void fraction (GVF). Then, an algorithm is implemented, which relates the observed frequency variation with the inhomogeneity of the medium, especially its gas volume fraction.

### SUMMARY

It is, therefore, an object of the present invention to provide a measuring device and a method, which enable a more simply implemented analysis of density variations with a greater independence from the particular form of the measuring device.

The object of the invention is achieved by the measuring devices and the methods according to the present disclosure.

The measuring device of the invention for determining density, mass flow rate and/or viscosity of a streaming, flowable medium comprises an oscillator, which has at least one measuring tube for conveying the medium, and which has at least one oscillatory mode, whose eigenfrequency depends on the density of the medium, and an exciter for exciting the oscillatory mode; as well as at least one oscillation sensor for registering oscillations of the oscillator; and an operating-evaluating circuit, which is adapted to supply the exciter with an excitation signal, to register signals of the oscillation sensor, based on the signals of the oscillation sensor to ascertain current values of the eigenfrequency of the oscillator as well as variations of the eigenfrequency, and to determine a value characterizing density variations of the medium, wherein the value depends on a function, which is proportional to variation of the eigenfrequency and has an eigenfrequency dependent normalization.

In general, density ρ of a medium can be ascertained based on a mode specific eigenfrequency fᵢ of an oscillatory mode according to:

$$ρ ( {f}_{i} ) = {c}_{0 , i} + \frac{{c}_{1 , i}}{{f}_{i}^{2}}$$

The coefficients c_{0,i} and c_{1,i} are mode specific coefficients, which preferably are ascertained for each measuring device type, or each measuring device. The coefficient c_{0,i} is influenced by the mass of the measuring tube conveying the medium, while the coefficient c_{1,i} depends on a mode specific stiffness of the measuring tube. The coefficient c_{0,i} is, as a rule, negative.

In another development of the invention, the function is proportional to the variation of the eigenfrequency and the third power of the reciprocal of the eigenfrequency. In an embodiment of this further development of the invention, the function is, additionally, proportional to a modal stiffness of the oscillator in the case of the oscillatory mode of the oscillator belonging to the eigenfrequency, especially proportional to the coefficient c_{1,i}.

In another development of the invention, the function is proportional to the variation of the eigenfrequency, and to the reciprocal of the eigenfrequency. In an embodiment of this further development of the invention, the function is, additionally, proportional to an inertial term, which has especially a sum of density and a term proportional to the modally effective mass of the oscillator in the case of the oscillatory mode belonging to the eigenfrequency.

The sum can especially have the form ρ+|c_{0,i}|. Selected for the density in the sum can be, for example, a constant typical for the particular medium, or an averaged density value, which is determined especially with a time constant, which is greater than ten times, especially greater than hundred times, the time constant for ascertaining the current density measured values.

The measuring tube, or the measuring tubes, can be straight or bent in the resting position. A bent measuring tube has preferably a mirror symmetry S2 or a rotational symmetry C2 perpendicularly to a measuring tube plane defined by its centerline.

An oscillator with exactly one bent, oscillatable, measuring tube, which has perpendicular to the measuring tube plane a mirror symmetry S2 or a C2 symmetry, is disclosed in patent application DE 10 2017 012 058.7, which was unpublished as of the earliest filing date of this application. The measuring tube can be excited to oscillate in different oscillation modes with different mode specific eigenfrequencies fᵢ. Fundamentally, density of a medium flowing in the measuring tube can be determined based on any of these eigenfrequencies. When frequency variations occur, for example, because of free bubbles in a liquid medium, the invention permits a reliable characterizing of the medium based on frequency variations, and, indeed, independently of the particular oscillation mode being used.

In an additional embodiment of the invention, the oscillator comprises a pair of oscillatable measuring tubes for conveying the medium. Due to the analysis of frequency variations according to the invention, also in this case, a simple, frequency independent characterizing of the medium can occur.

In another embodiment of the invention, the measuring device comprises two mutually independent oscillators with, in each case, a pair of measuring tubes, wherein the two oscillators have different excitation mode eigenfrequencies for a bending oscillation, excitation mode. In the case of this embodiment of the invention, the analysis of the frequency variations according to the invention for characterizing the medium has special meaning. Ordinarily, bent measuring tubes are so directed that the measuring tubes are emptiable, thus the measuring tube bend points upwardly, wherein especially a first oscillator with two longer measuring tubes is arranged above a second oscillator with two shorter measuring tubes, wherein the measuring tubes of the two oscillators extend essentially in parallel as well as inlet end and outlet end are joined in manifolds. The first oscillator has for a bending oscillation excitation mode a lesser eigenfrequency than the second oscillator for corresponding bending oscillation excitation mode. Such a measuring device is disclosed in WO 2016 107 694 A1. Due to the arrangement of the oscillators on top of one another and the buoyancy acting on free bubbles, the free bubbles can be enriched in the measuring tubes of the first resonator compared with that of the second resonator. The analysis of the frequency variations according to the invention enables reliably detecting the relative enrichment of the free bubbles in the first oscillator, in spite of the different eigenfrequencies, whereby a valuable indication of the mobility of the free bubbles in the medium can be obtained.

In another embodiment of the invention, the measuring device comprises two coupled oscillators with, in each case, a pair of measuring tubes, wherein the coupled oscillators have an equal phase and an opposite phase bending oscillation excitation mode with, in each case, different excitation mode eigenfrequencies. Such a measuring device is disclosed in the patent application DE 10 2016 125 615.3, which was unpublished as of the earliest filing date of this application. The analysis of the frequency variations according to the invention can be performed at both excitation mode eigenfrequencies and enables a frequency independent characterizing of the medium.

In a further development of the invention, the value characterizing the medium comprises an index for classifying the medium.

The determining of a measured value of mass flow for the medium occurs in known manner based on a phase difference between an inlet side oscillation sensor and an outlet side oscillation sensor. The determining of a viscosity measured value of the medium can occur, for example, in known manner based on an amplitude ratio between excitation signal and the signals of the oscillation sensors. In a further development of the invention, the operating-evaluating circuit is adapted to associate with a density measured value, a mass flow, measured value and/or a viscosity measured value an evaluation, which depends on the value characterizing the density variation, and, for example, indicates the degree of inhomogeneity of the medium.

The method of the invention for determining density, mass flow rate and/or viscosity of a flowable medium, especially with a measuring device of the invention, comprises: Exciting and registering oscillations of at least one oscillatory mode of an oscillator, which is supplied with the medium, wherein the at least one oscillatory mode has an eigenfrequency, which depends on density of the medium; ascertaining a sequence of current values of the eigenfrequency of the oscillator as well as variations of the eigenfrequency; and determining a value characterizing density variations of the medium, wherein the value depends on a function, which is proportional to the variation of the eigenfrequency and has an eigenfrequency dependent normalization.

In a further development of the method of the invention, the function is proportional to the variation of the eigenfrequency and to the third power of the reciprocal of the eigenfrequency. In an embodiment of this further development of the invention, the function is further proportional to a modal stiffness of the oscillator in the case of the oscillatory mode of the oscillator belonging to the eigenfrequency.

In a further development of the method of the invention, the function is proportional to the variation of the eigenfrequency, to the reciprocal of the eigenfrequency and to the reciprocal value of a sum of density and a modally effective mass of the oscillator in the case of the oscillatory mode of the oscillator belonging to the eigenfrequency.

In a further development of the method of the invention, the value characterizing the medium comprises an index for classifying the medium, especially for classifying such as regards its gas load.

### BRIEF DESCRIPTION OF THE DRAWINGS

The invention will now be described based on examples of embodiments illustrated in the drawing, the figures of which show as follows:

FIG. 1a shows a schematic view of a first example of an embodiment of a densimeter of the present disclosure;

FIG. 1b shows a schematic view of a second example of an embodiment of a densimeter of the present disclosure;

FIG. 1c shows a schematic view of a third example of an embodiment of a densimeter of the present disclosure;

FIG. 1d shows a schematic view of a fourth example of an embodiment of a densimeter of the present disclosure; and

FIG. 2 shows a flow diagram of a first example of an embodiment of the method of the present disclosure.

### DETAILED DESCRIPTION

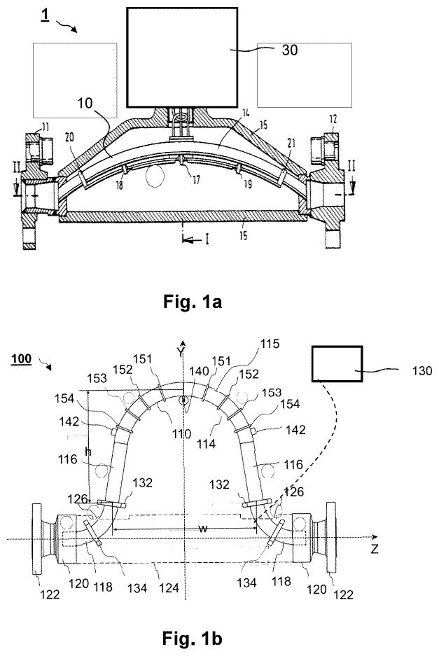

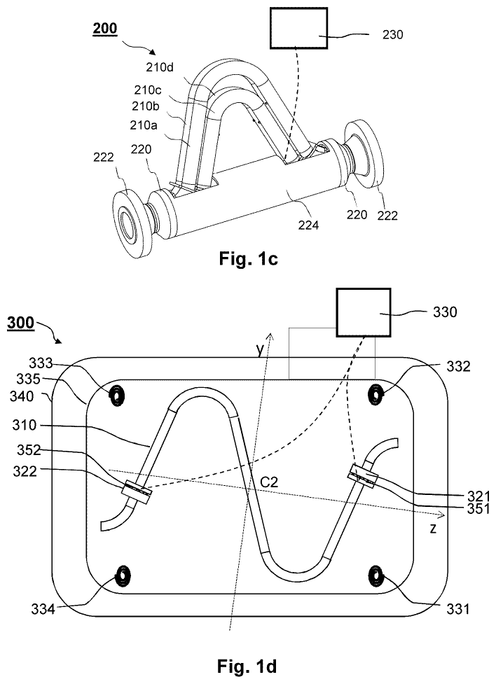

The mass flow meters illustrated in FIGS. 1a to 1d operate according to the Coriolis principle and are all known as regards the structure of their measuring transducers. The oscillators of these measuring transducers have different eigenfrequencies at given media density. By further development to become densimeters of the invention, these devices can characterize density variations of a medium in comparable manner.

The first example of an embodiment of a measuring device 1 of the invention shown in FIG. 1a has an oscillator 10, which includes a pair of parallel, oscillatable, measuring tubes 14, which extend between an inlet end flange 11 and an outlet end flange 12, wherein each flange includes a manifold serving as a flow divider, or flow collector, as the case may be. Thus, the measuring tubes 14 are connected with the manifolds. The manifolds are connected together by a rigid housing 15, so that oscillations of the manifolds connected with the measuring tubes are effectively suppressed in the range of oscillation frequencies of bending oscillation, excitation modes of the oscillator. The measuring tubes 10 are connected rigidly with an inlet-side node plate 20 and an outlet-side node plate 21, wherein the node plates define oscillation nodes of the oscillator 10 formed by the two measuring tubes 14, and therewith largely establish the frequencies of the bending oscillation, excitation modes. The oscillator 10 is excited to oscillate by an electrodynamic exciter 17 acting between the two measuring tubes 14, wherein the oscillations are detected by means of two oscillation sensors 18, 19 registering movements of the measuring tubes 14 relative to one another. The exciter 17 is operated by an operating-evaluating circuit 30, which also registers and evaluates the signals of the oscillation sensors, in order to ascertain a density measured value and, in given cases, a mass flow, measured value. The operating-evaluating circuit 30 of the invention is likewise adapted to ascertain and to signal density variations based on frequency variations.

The second example of an embodiment of a measuring device 100 of the invention shown in FIG. 1b has an oscillator 110, which includes a pair of parallel, oscillatable, measuring tubes 114, which extend between inlet-side and outlet-side manifolds 120. The measuring tubes 14 are connected with the manifolds. Adjoining each manifold is a flange 122 for mounting the measuring device 100 into a pipeline. The manifolds 120 are connected together by a rigid support tube 124, so that oscillations of the manifolds connected with the measuring tubes 114 are effectively suppressed in the range of oscillation frequencies of bending oscillation, excitation modes of the oscillator 110. The measuring tubes 114 are connected rigidly together on the inlet- and outlet-sides, in each case, by means of two node plates 132, 134, wherein the node plates define oscillation nodes of the oscillator 110 formed by the two measuring tubes 114, and therewith largely establish the frequencies of the bending oscillation, excitation modes. The measuring tubes 114 have relative to a longitudinal distance w between the inner the node plates 132 a significantly higher measuring tube bend with a height h, than is the case in the first example of an embodiment. For this, the measuring tubes have at inlet end and outlet end, in each case, adjoining the manifold 120, an upwardly directed, arc shaped section 118, which emerges from a cavity 126 of the support tube 124. Following on the arc shaped sections 118, in each case, is a straight section 116, wherein the straight sections are connected by an arc shaped central section 115. The central sections 115 of the two measuring tubes have, in each case, annular stiffening elements 151, 152, 153, in order to minimize a cross-sensitivity of the measuring device to pressure variations. The shape of the measuring tubes 114 of the second example of an embodiment is optimized to maximize accuracy of density measurement. The higher bend of the measuring tubes 114 leads compared with the first example of an embodiment in the case of comparable bending oscillation modes, however, to significantly lower eigenfrequencies.

Oscillator 110 is excited to oscillate using an electrodynamic exciter 140 acting between the two measuring tubes 114, wherein the oscillations are detected by means of two oscillation sensors 142 registering relative movements of the measuring tubes 114. Exciter 140 is operated by an operating-evaluating circuit 130, which also registers and evaluates the signals of the oscillation sensors, in order to ascertain a density measured value and, in given cases, a mass flow, measured value. The operating-evaluating circuit 130 of the invention is likewise adapted to ascertain and to signal density variations based on frequency variations.

The third example of an embodiment of a measuring device 200 of the invention shown in FIG. 1c has a first oscillator, which includes a first pair of parallel, oscillatable, measuring tubes 210a and 210 b, and a second oscillator, which includes a second pair of parallel, oscillatable, measuring tubes 210c and 210 d. All measuring tubes extend between inlet-side and outlet-side manifolds 220, to which they are connected, wherein there adjoins the manifolds 220, in each case, a flange 222 for insertion of the measuring device 200 into a pipeline. Manifolds 220 are connected together by a rigid support tube 224, so that oscillations of the manifolds connected to the measuring tubes are effectively suppressed in the range of oscillation frequencies of bending oscillation, excitation modes of the oscillators. The measuring tubes of the first oscillator have compared with the measuring tubes of the second oscillator a significantly higher measuring tube bend, so that the eigenfrequencies of the bending oscillation modes of the first oscillator are significantly lower than the eigenfrequencies of the corresponding bending oscillation modes of the second oscillator. The oscillators are, in each case, excited to oscillate using an electrodynamic exciter acting between the two measuring tubes of the oscillator, wherein the oscillations are, in each case, detected by means of two oscillation sensors registering relative movements of the measuring tubes. The exciters (not shown) are fed with excitation signals by an operating-evaluating circuit 230, wherein the operating-evaluating circuit 230 is also equipped to register and to evaluate signals of oscillation sensors (likewise not shown), in order to ascertain a density measured value and, in given cases, a mass flow, measured value. The operating-evaluating circuit 230 of the invention is likewise adapted to ascertain and to signal density variations based on frequency variations.

The third example of an embodiment of a measuring device 300 of the invention shown in FIG. 1d has an oscillator, which has an s-shaped, oscillatable, measuring tube 310 with a C2 symmetry perpendicular to the measuring tube plane. The measuring tube 310 is held inlet end and outlet end in rigid bearing blocks 321, 322, which on their part are anchored on a rigid support plate 335, so that oscillations of the bearing blocks 321, 322 in the range of oscillation frequencies of bending oscillation, excitation modes of the oscillator are effectively suppressed. Support plate 335 is connected via helical springs 331, 332, 333, 334 to a housing base 340 and decoupled from oscillations of the housing base in the range of oscillation frequencies of bending oscillation, excitation modes of the oscillator. Arranged on the bearing blocks 321, 322, in each case, is an integrated piezoelectric exciter—and sensor unit 351, 352, with which the oscillator can be excited in bending oscillation modes within the measuring tube plane and perpendicular thereto. The bending oscillations of the oscillator can likewise be registered by means of the integrated piezoelectric exciter—and sensor units 351, 352, which are connected with an operating-evaluating circuit 330. The operating-evaluating circuit 330 feeds the integrated piezoelectric exciter- and sensor units 351, 352 with excitation signals and registers sensor signals dependent on its oscillation, in order in this way to ascertain a density measured value and, in given cases, a mass flow, measured value. The operating-evaluating circuit 330 of the invention is likewise adapted to ascertain and to signal density variations based on frequency variations. This measuring device type is described in detail in DE 10 2017 012 058.7, which was unpublished as of the earliest filing date of this application. The bending oscillation modes have eigenfrequencies between a number of hundred Hz and a number of kHz. Instead of the measuring tube illustrated here with C2 symmetry, the oscillator can also have a measuring tube with a mirror symmetry perpendicular to the measuring tube plane, for example, be a U-shaped measuring tube, which likewise is provided with integrated piezoelectric exciter- and sensor units. Also, such an oscillator has bending oscillation modes with eigenfrequencies between a number of hundred Hz and a number of kHz, such as is described in DE 10 2017 012 058.7, which was unpublished as of the earliest filing date of this application.

Common to all described forms of embodiment is that either different oscillation frequencies can occur within a measuring device, or that, in the case of comparison between different implementations of a device type, different eigenfrequencies of the oscillator would make an analysis of density variations based on frequency variations difficult without implementation of the present invention.

The density ρ of a medium can be ascertained by means of a densimeter, which has an oscillator containing at least one oscillatable measuring tube for conveying the medium, based on a mode specific, density dependent eigenfrequency fᵢ of the oscillator, according to the formula:

$$ρ ( {f}_{i} ) = {c}_{0 , i} + \frac{{c}_{1 , i}}{{f}_{i}^{2}}$$

The coefficients c_{0,i} and c_{1,i} are mode specific coefficients, which preferably are ascertained for each measuring device type, or each measuring device. The coefficient c_{0,i} is influenced by the mass of the measuring tube conveying the medium, while the coefficient ci,i depends on a mode specific stiffness of the measuring tube. The derivative of the density with respect to time, ∂ρ/∂t, is at thus:

$$\frac{\partial ρ}{\partial t} = {c}_{1 , i} \frac{2}{{f}_{i}^{3}} \frac{\partial {f}_{i}}{\partial t} .$$

The derivative of the density with respect to time,

$$\frac{\partial ρ}{\partial t} ,$$

is a suitable measure for description of density variation. In order to ascertain this value, the observed frequency variation

$$\frac{\partial {f}_{i}}{\partial t}$$

of the oscillating measuring tube, or the oscillating measuring tubes, as the case may be, is according to the invention multiplied with a normalizing factor

$${c}_{1 , i} \frac{2}{{f}_{i}^{3}} .$$

In this way, the basis for an evaluation function is created, which can describe the degree of inhomogeneity of the medium in the form of density variations independently of the particular type of densimeter, or its size. The operating-evaluating circuits 30; 130; 230; 330 of the above examples of embodiments of a measuring device of the invention are in an embodiment of the invention equipped to provide density variation based on frequency variation by means of the above explained normalization with the reciprocal of the third power of the mode specific eigenfrequency:

$$\frac{\partial ρ}{\partial t} = {c}_{1 , i} \frac{- 2}{{f}_{i}^{3}} \frac{\partial {f}_{i}}{\partial t} .$$

To illustrate the effect of the invention, data for two Coriolis mass flow measurement devices of the applicant, namely a Promass F50 and a Promass Q50, were used. Both of these have the function of a density measuring device. The observed eigenfrequency variations

$$\frac{\partial {f}_{i}}{\partial t}$$

differ in the case of an aqueous medium with a gas load from 1% or 2% by a factor of, for instance, 6.6. After normalizing with the normalizing factor

$${c}_{1 , i} \frac{2}{{f}_{i}^{3}} ,$$

there results in the case of both devices essentially the same value for the density variation

$$\frac{\partial ρ}{\partial t} .$$

An equivalent analysis of the density variation

$$\frac{\partial ρ}{\partial t}$$

is implemented in a second embodiment of the invention. In such case, the operating-evaluating circuit is adapted to ascertain density variation according to the formula:

$$\frac{\partial ρ}{\partial t} = \frac{2 ( ρ - {c}_{0 , i} )}{{f}_{i}} \frac{\partial {f}_{i}}{\partial t} .$$

For providing the magnitude of the specific gravity variation

$$\frac{\frac{\partial ρ}{\partial t}}{ρ} ,$$

the operating-evaluating circuit according to a third embodiment of the invention is adapted to ascertain such based on the relative frequency variation

$$\frac{\frac{\partial {f}_{i}}{\partial t}}{{f}_{i}}$$

according to the formula:

$$\vert \frac{\frac{\partial ρ}{\partial t}}{ρ} \vert = 2 ( 1 + \frac{\vert {c}_{0 , i} \vert}{ρ} ) \vert \frac{\frac{\partial {f}_{i}}{\partial t}}{{f}_{i}} \vert$$

When density of the medium at a measuring point varies by only a few percent around a known value and is known to lie within the value range, the specific gravity variation can be estimated as a function of relative frequency variation according to the formula:

$$\vert \frac{\frac{\partial ρ}{\partial t}}{ρ} \vert \approx {a}_{i} \vert \frac{\frac{\partial {f}_{i}}{\partial t}}{{f}_{i}} \vert ,$$

wherein aᵢ is a measuring point-specific, or media specific and, in given cases, mode specific, constant, to the extent that more than one mode can be used for density measurement.

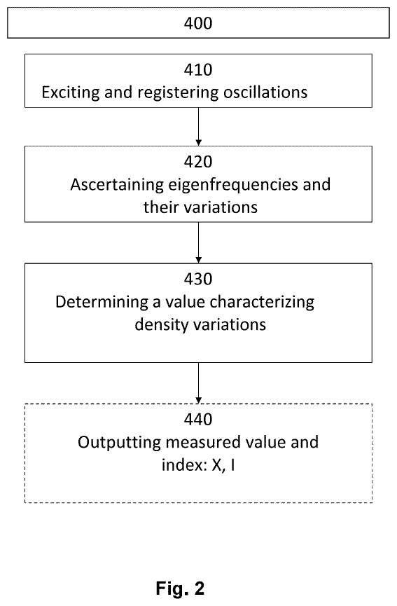

An example of an embodiment 400 of the method of the invention will now be explained based on FIG. 2.

In a first step 410, the exciting and registering of oscillations of at least one oscillatory mode of an oscillator supplied especially with a flowing medium occurs. The at least one oscillatory mode has an eigenfrequency, which depends on density of the medium. Thus, the exciting of the oscillations occurs in a control loop, in which the excitation frequency is controlled, for example, in order to maximize the oscillation amplitude, or in order to maintain a constant phase angle between 45° and 135° between excitation signal and deflection of the oscillator.

In the next step 420. the current excitation frequencies are registered, which correspond to the current values of the eigenfrequencies of the oscillator. Based on the registered current excitation frequencies, and eigenfrequencies, respectively, a sequence of these values is formed, based on which the variations of eigenfrequency are ascertained, for example, by suitable digital filters.

In a next step 430, there follows normalizing with one of the above factors, in order to ascertain a value for density variation for the measuring device.

In an optional step 440, the so ascertained value of density variation, or an index value I derived therefrom, can be output together with a measured value X, which can be a density measured value, a mass flow, measured value or viscosity measured value, for validation of the measured value X. From the index I, which describes, for example, the degree of inhomogeneity of the medium, it can be concluded, how valid the measured value X is.

We claim:

1. A measuring device for determining density, mass flow rate and/or viscosity of a flowable medium, the measuring device comprising:
an oscillator including at least one oscillatable measuring tube adapted to convey the medium and to have at least one oscillatory mode, whose eigenfrequency depends on a density of the medium, wherein a type of the measuring device is defined by a configuration of the oscillator;
an exciter configured to excite the at least one oscillatory mode;
at least one oscillation sensor configured to detect oscillations of the oscillator and to generate signals representing the detected oscillations; and
an operating-evaluating circuit configured to:
supply the exciter with an excitation signal;
register the signals of the oscillation sensor;
ascertain current values of the eigenfrequency of the oscillator and fluctuations of the eigenfrequency based on the signals of the oscillation sensor; and
determine a value characterizing density fluctuations of the medium, which density fluctuations arise from inhomogeneities in the medium, wherein the value depends on a function which is proportional to the fluctuations of the eigenfrequency and is normalized by a reciprocal of the third power of the eigenfrequency such that the value is substantially independent of the type of measuring device.

2. The measuring device of claim 1, wherein the function is further proportional to a modal stiffness of the oscillator at an oscillatory mode belonging to the eigenfrequency.

3. The measuring device of claim 1, wherein the at least one measuring tube is bent and has a mirror symmetry or a rotational symmetry perpendicular to a measuring tube plane defined by a centerline of the at least one measuring tube.

4. The measuring device of claim 3, wherein the operating-evaluating circuit is configured to excite the at least one measuring tube to oscillate in different oscillation modes with different mode-specific eigenfrequencies.

5. The measuring device of claim 1, wherein the at least one measuring tube of the oscillator includes at least one pair of oscillatable measuring tubes, each configured to convey the medium.

6. The measuring device of claim 1, wherein the measuring device comprises two mutually independent oscillators, each including a pair of oscillatable measuring tubes, wherein the two oscillators have different excitation mode eigenfrequencies for a bending oscillation excitation mode.

7. The measuring device of claim 1, wherein the value characterizing density fluctuations of the medium comprises an index for classifying the medium with respect to a gas load of the medium.

8. The measuring device of claim 1, wherein the operating-evaluating circuit is further configured to attribute a degree of inhomogeneity of the medium, which depends on the value characterizing the density fluctuations of the medium, with a measured value of at least one a density, a mass flow, and a viscosity as determined using the measuring device as an evaluation of a validity of the measured value.

9. The measuring device of claim 1, wherein the function is substantially independent of a specific construction and/or flow capacity of the measuring device.

10. A method for determining density, mass flow rate and/or viscosity of a flowable medium, the method comprising:
exciting and detecting oscillations of at least one oscillatory mode of an oscillator, which is supplied with the medium, wherein the at least one oscillatory mode has an eigenfrequency which depends on a density of the medium;
ascertaining a sequence of current values of the eigenfrequency of the oscillator and fluctuations of the eigenfrequency;
determining a value characterizing density fluctuations of the medium, which density fluctuations arise from inhomogeneities in the medium, wherein the value depends on a function which is proportional to the fluctuations of the eigenfrequency and is normalized by a reciprocal of the third power of the eigenfrequency such that the value is substantially independent of the type of measuring device.

11. The method of claim 10, further comprising attributing a degree of inhomogeneity of the medium, which depends on the value characterizing the density fluctuations of the medium, with a measured value of at least one a density, a mass flow, and a viscosity as determined using the oscillator as an evaluation of a validity of the measured value.

12. The method of claim 10, wherein the value characterizing density fluctuations of the medium comprises an index for classifying the medium with respect to a gas load of the medium.

13. The method of claim 10, wherein the function is substantially independent of a specific construction and/or flow capacity of the oscillator.

14. The method of claim 10, wherein the function is further proportional to a modal stiffness of the oscillator at an oscillatory mode belonging to the eigenfrequency.
